(19) United States
(12) Patent Application Publication
(10) Pub. No.: US 2007/0141198 A1
(43) Pub. Date: Jun. 21, 2007

(54) MULTILAYERED CONFECTIONERY PRODUCTS AND METHODS REGARDING SAME

(76) Inventor: Marguerite Yang, Wilmette, IL (US)

Correspondence Address: BELL, BOYD & LLOYD LLP, P.O. Box 1135, CHICAGO, IL, 60690, US

(21) Appl. No.: 11/552,420

(22) Filed: Oct. 24, 2006

Related U.S. Application Data
(60) Provisional application No. 60/752,510, filed on Dec. 21, 2005.

(51) Int. Cl. A23G 4/00

(52) U.S. Cl. 426/3

(57) ABSTRACT

Multilayered confectionery products and methods for making same are provided. In an embodiment, the present invention provides a confectionery product comprising at least distinct three confectionery layers, wherein at least one of the confectionery layers has a first texture during processing and a second texture after processing that is different from the first texture. The differences in texture can result from, for example, water or oil migration between adjacent layers.

### PRIORITY CLAIM

This application claims the benefit of U.S. Provisional Patent Application Ser. No. 60/752,510 filed on Dec. 21, 2005, the entire disclosure of which is hereby incorporated.

### BACKGROUND

The present invention relates generally to confectionery products. More specifically, the present invention relates to multilayered confectionery products and methods regarding the same.

There are numerous types of confectionery products or compositions having a dual layers. Such confectionery products can include, for instance, chewing gum or candy. Processing complications exist in making dual layered products with layers that are texturally distinctive from each other. Moreover, some layer textures are too difficult to process in their final desired textural form (e.g. hard or soft). Nevertheless, consumers would enjoy a confectionery having a multilayered composition where each layer has a distinct texture.

It is therefore desirable to produce unique confectionery products having multiple layers where each layer has greater stability and control with respect to moisture and structural stability.

### SUMMARY

The present invention relates to multilayered confectionery products and methods of making same. For example, in an embodiment, the present invention provides a confectionery product comprising at least three or more distinct confectionery layers.

In an embodiment, at least one of the confectionery layers has a first texture during processing and a second texture after processing (e.g. post-processing) that is different from the first texture.

In an embodiment, the change from the first texture to the second texture of the confectionery layer is caused by water migration between adjacent confectionery layers.

In an embodiment, each of the confectionery layers has its own water activity and wherein the water migration is caused by differences in the water activities between the adjacent confectionery layers.

In an embodiment, the change from the first texture to the second texture of the confectionery layer is caused by oil migration between adjacent confectionery layers.

In an embodiment, each of the confectionery layers has its own oil concentration and wherein the oil migration is caused by differences in the oil concentration between the adjacent confectionery layers.

In an embodiment, at least each of the confectionery layers is a material selected from the group consisting of chewing gum, powder, liquid, paste, hard candy, fat-based confectionery, crystallized pastes, pressed tablets, solid foam, shear thickening fluid, rework and combinations thereof.

In an embodiment, one of the confectionery layers comprises a coating.

In an embodiment, the coating comprises at least one component selected from the group consisting of sugars, polyols and combinations thereof.

In an embodiment, the confectionery layers comprise at least one ingredient selected from the group consisting of malted products, sweeteners, flavors, colors, sensates, acids, medicaments, actives and combinations thereof.

In an embodiment, at least one of the layers comprises a candy composition selected from the group consisting of hard boiled, chewy, caramel, fondant, chocolate, compound coating, jelly, gummy, glassy, crystalline, nougat, licorice, taffy, fruit leather and combinations thereof.

In another embodiment, the present invention provides a confectionery product comprising at least three confectionery layers. The first layer comprises a confectionery center. The second layer comprises a coating surrounding the confectionery center. The third layer comprises a confectionery shell. The coating provides a barrier to control water migration between the confectionery center and the confectionery shell due to hydroscopic characteristics.

In yet another embodiment, the present invention provides a confectionery product comprising at least three confectionery layers. The first layer comprises a confectionery center. The second layer comprises a coating surrounding the confectionery center. The third layer comprises a confectionery shell. The coating provides a barrier to control water migration between the confectionery center and the confectionery shell due to hydrophobic characteristics.

In an alternative embodiment, the present invention provides a confectionery product comprising at least three confectionery layers. The first layer comprises a confectionery center. The second layer comprises a coating surrounding the confectionery center. The third layer comprises a confectionery shell. The coating provides a barrier to control oil migration between the confectionery center and the confectionery shell due to lipophobic characteristics.

In another embodiment, the present invention provides a confectionery product comprising at least three confectionery layers. The first layer comprises a confectionery center. The second layer comprises a confectionery shell surrounding the confectionery center. The third layer comprises a another confectionery shell surrounding the second layer. The first layer, the second layer and the third layer each has a water content or water activity that causes or prevents water migration between the adjacent layers. As a result, the first layer, the second layer and the third layer may each have a texture that changes due to the water migration.

In yet another embodiment, the present invention provides a confectionery product comprising at least three confectionery layers. The first layer comprises a confectionery center. The second layer comprises a confectionery shell surrounding the confectionery center. The third layer comprises another confectionery shell surrounding the second layer. The first layer, the second layer and the third layer each has an oil content that causes or prevents oil migration among the liquid center, edible casing and confectionery shell. As a result, the first layer, the second layer and the third layer each may have a texture that changes due to the oil migration.

In an alternative embodiment, the present invention provides a method of making a confectionery product. For example, the method comprises providing a first confectionery center layer; surrounding the first confectionery center layer with a second confectionery layer; surrounding the second confectionery layer with a third confectionery layer; and allowing a component selected from the group consisting of water, oil and combinations thereof to migrate between the layers of the confectionery product.

In still another embodiment, the present invention provides a method of making a confectionery product. For example, the method comprises depositing at least one confectionery center layer into a mold; and adding a second confectionery layer to the mold to surround the confectionery center layer with the second confectionery layer; adding a third confectionery layer to the mold to surround the second confectionery layer with the third confectionery layer; and allowing a component selected from the group consisting of water, oil and combinations thereof to migrate between the layers of the confectionery product.

In another embodiment, the present invention provides a method of making a multilayered confectionery product. For example, the method comprises adding a first confectionery material, a second confectionery material and a third confectionery material to an extruder; co-extruding the first, second and third confectionery materials to form the multilayered confectionery product; cutting the multilayered confectionery product into pieces; and allowing a component selected from the group consisting of water, oil and combinations thereof to migrate between the materials of the multilayered confectionery product.

In yet another embodiment, the present invention provides a method of making a multilayered confectionery product. For example, the method comprises providing a first confectionery material, a second confectionery material and a third confectionery material; co-depositing the confectionery materials on to an apparatus selected from the group consisting of a mold, a belt and combinations thereof to form the multilayered confectionery product; and allowing a component selected from the group consisting of water, oil and combinations thereof to migrate between the layers of the multilayered confectionery product.

In an alternative embodiment, the present invention provides a method of making a confectionery product. For example, the method comprises providing a first confectionery layer; laminating the first confectionery layer with a second confectionery layer; laminating the second confectionery layer with a third confectionery layer; and allowing a component selected from the group consisting of water, oil and combinations thereof to migrate between the layers of the confectionery product.

In yet another embodiment, the present invention provides a method of making a confectionery product, the method comprising: providing a first confectionery layer; adding a second confectionery layer to the first confectionery layer; adding a third confectionery layer to the second confectionery layer; and preventing a component selected from the group consisting of water, oil and combinations thereof from migrating between the layers of the confectionery product.

As discussed in detail below, the migration of water content and/or oil content between the confectionery materials or layers can be promoted or prevented by controlling the amount of water content, water activity, oil content or combinations thereof in each material or layer before, during and/or after processing of the confectionery product.

An advantage of the present invention is to provide a multilayered confectionery having unique textural layers.

Another advantage of the present invention is to provide a multilayered confectionery product that has controlled moisture (e.g. water) and/or oil migration between the adjacent layers of the confectionery product.

Still another advantage of the present invention is to provide an improved process for making a multilayered confectionery products.

Additional features and advantages are described herein, and will be apparent from, the following Detailed Description and the Figures.

### BRIEF DESCRIPTION OF THE FIGURES

FIG. 1 illustrates a cross-section view of the multilayered confectionery product in one embodiment of the present invention.

FIG. 2 illustrates a cross-section view of the multilayered confectionery product in another embodiment of the present invention.

FIG. 3 illustrates a cross-section view of the multilayered confectionery product in an alternative embodiment of the present invention.

### DETAILED DESCRIPTION

The present invention relates to confectionery products. More specifically, the present invention relates to multilayered compositions having three or more distinct layers and methods for making same.

In an embodiment, the multilayered confectionery products can have confectionery layers each having a different characteristic (e.g. color, flavor, texture, moisture content, water content, etc.). In another embodiment, the multilayered confectionery products can be produced wherein the confectionery streams that form the final multilayered composition having a different initial processing characteristic than that of its post-processing character. In other words, the layers of the multilayered confectionery product can having one characteristic at the time of processing and another characteristic after processing (e.g. post-processing) and/or at the time of consumption by a consumer (e.g. due to moisture or oil migration between layers of the product).

The rate of water and/or oil migration can determine how quickly the texture of the confectionery layers changes over time upon processing. Water and/or oil migration between layers can be prevented and/or promoted by controlling the water/oil levels and/or water activities (Aw) of each layers. For example, water and oil migration between adjacent confectionery layers may be greater if the differences of the water/oil levels and/or water activities of each layer are large. Conversely, water and oil migration between adjacent confectionery layers may be insubstantial or not occur at all if the differences of the water/oil levels and/or water activities of each layer are similar or the same. Alternatively, a confectionery barrier layer may be used to control water/oil migration between layers.

In the present specification, the term “confectionery layer” should be understood to mean any of the distinct confectionery components of the multilayered confectionery products of the present invention. For example, the confectionery layers can refer to any of the confectionery center (e.g. core) and the surrounding coatings and shells of the confectionery products.

In the present specification, the term “coating” should be understood to mean a covering of a material spread over a surface, for example, by using a coating syrup. In embodiments of the present invention, a coating (e.g. coating layer) can be applied to the surface of the confectionery core or the surface of one of the confectionery shells or both. For example, the coating layer can be used for protection, decoration, taste, etc. In addition, the coating layer can act a barrier to prevent or control water or oil migration through the coating layer. It should be appreciated that the coatings and confectionery shells as used herein are distinct components in embodiments of the present invention.

In the present specification, the term “shell” should be understood to mean a confectionery material such as, for example, a chewing gum or candy that surrounds another material. For example, a first confectionery shell can surround a confectionery core or center material. A second confectionery shell can surround the first confectionery shell. A third confectionery shell can surround the second confectionery shell and so on. The candy composition can be, for example, any suitable confectioneries capable of forming the shell.

In the present specification, the term “water or oil based liquid” should be understood to mean compositions having any amount of water or oil, respectively. For example, the water or oil based liquid can be in the form of syrups, solutions, emulsions, suspensions, pastes, gels, etc. Further, the water or oil based liquid can comprise additional materials such as, for instance, particulates, crystals, particles, nonpareils, smaller beads, etc.

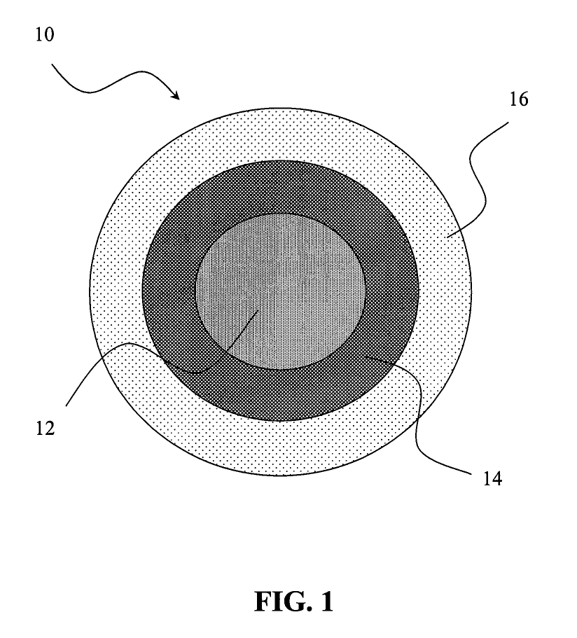

In an embodiment illustrated in FIG. 1, the present invention provides a confectionery product 10 comprising three or more layers. For example, the confectionery product 10 can comprise a confectionery core or center 12 with a first confectionery layer or shell 14 surrounding the center 12 and a second confectionery layer or shell 16 surrounding the first shell 14.

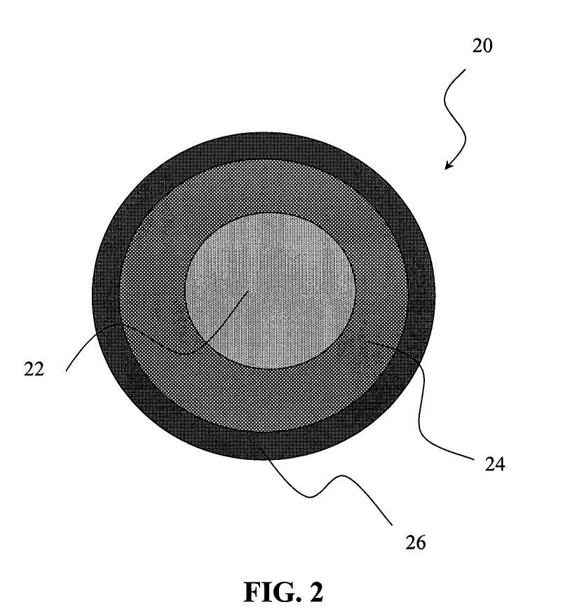

In another embodiment illustrated in FIG. 2, the present invention provides a confectionery product 20 comprising a confectionery center 22 with a first confectionery shell 24 surrounding the center 22 and a coating layer 26 surrounding the first confectionery shell 24. It should be appreciated that one or more additional layers in the form of a confectionery shell or coating can surround the outermost confectionery shell or the coating layers.

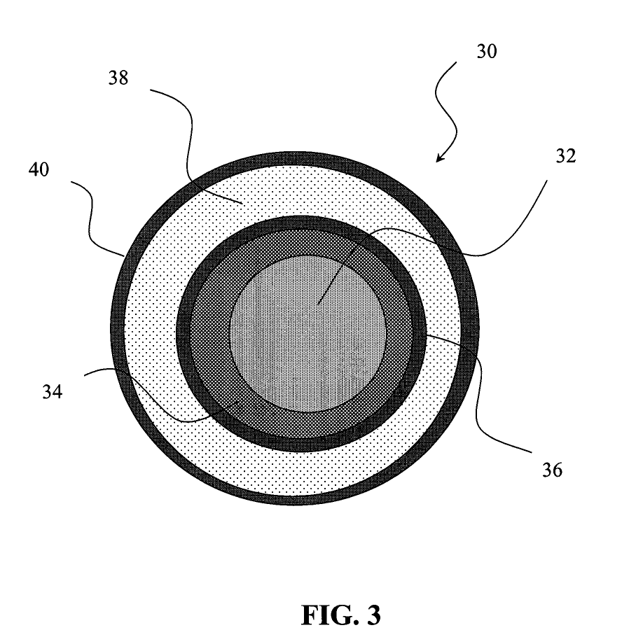

In an alternative embodiment illustrated in FIG. 3, the present invention provides a confectionery product 30 comprising a confectionery center 32 with a first confectionery shell 34 surrounding the center 32 and a first coating layer 36 surrounding the first confectionery shell 24. In addition, a second confectionery shell 38 surrounds the first coating layer 36 and a second coating layer 40 surrounds the second confectionery shell 38.

In an embodiment, at least each of the confectionery layers is a material such as, for example, chewing gum, powder, liquid, paste, hard candy, fat-based confectionery, crystallized pastes, pressed tablets, solid foam, shear thickening fluid, rework or combinations thereof. It should be appreciated that rework may include, for example, ancillary and reusable confectionery trim, scrap and other non-virgin material made during the confectionery manufacturing processes as understood by the skilled artisan. The confectionery layers can comprise materials that are genetically modified organism (GMO) free.

In an embodiment, the confectionery cores or centers can comprise a powder, liquid, gum or jelly candy, chewy candy, bubble gum, chocolate, fondant, nougat, compound coating, caramel, taffy, fruit leather and combinations thereof. The first confectionery layer or shell can comprise a powder, liquid, gum or jelly candy, chewy candy, bubble gum, chocolate, fondant, nougat, compound coating, caramel, taffy, fruit leather and combinations thereof. Each additional confectionery layer or shell can also comprise a powder, liquid, gum or jelly candy, chewy candy, bubble gum, chocolate, fondant, nougat, compound coating, caramel, taffy, fruit leather and combinations thereof.

It should be appreciated that the multilayered confectionery products in embodiments of the present invention can be any suitable size or shape such as, for example, a pellet, sphere, cube, cigarette, spiral, etc. The confectionery layers can have any suitable thickness. Any of the layers (including the center) can comprise particulates, crystals, particles, nonpareils, smaller beads, etc. The particulates may be, for example, confectionery pieces, vegetable pieces, fruit pieces and/or particulates of sugar, polyols, gum or any other suitable food products. Any of the layers (including the center) can contain swirl patterns and/or semi-random non-homogenous fluid components, for example, non-concentric circular layers.

As illustrated in embodiments in FIGS. 2 and 3, the coating layers can comprise suitable coating material such as, for example, sugars, polyols or combinations thereof to form a crystalline or glassy coating. The sugar or polyols can be, for example, a component of a syrup or spray that is applied to the confectionery center or shells. Alternatively, molten sugars or molten polyols can be applied to the confectionery center or shells. This crystalline or glassy coating can serve, for example, to control water or oil migration between the various layers of the confectionery product. It should be appreciated that the coatings (along with any other confectionery material) can be applied to the confectionery center or shells by any suitable coating method such as, for example, spraying, panning, bath, curtain, etc.

Optionally, flavors may be separately sprayed onto the confectionery layers during the coating process to provide a flavored coating. Optionally, a polishing coat or dusting may be applied to the confectionery layers before or after the coatings have been applied. The polishing coat may use a wax, such as carnauba wax, or shellac. It may also include fillers such as talc and colors.

The coatings can provide a number of additional benefits to the multilayered confectionery. For example, the coating can give physical crush/compression strength to the multilayered confectionery thereby reducing its deformity and breakage characteristics. The coating can give heat stability to the layers of the confectionery product that are made of materials having low melting characteristics. The coating can also provide protection/barrier to control or prevent flavor, oil and/or moisture migration between the confectionery layers. In addition, the coating can also provide the liquid or pasty confectionery centers with a flavor burst as the liquid center confectionery product is being chewed. The benefits that derive from the coating also allow a greater range of materials that can be suitably used in the multilayered confectionery product.

In another embodiment, the outer most layer of the multilayered confectionery product can comprise a glassy, chewy or crystalline confectionery material. For example, this outer most layer can provide additional texture, structure and protection to the entire multilayered composition. In an alternative embodiment, the outermost layer can comprise a chocolate or compound coating or other fat-based containing confectionery material that provides texture, structure and protection to the entire multilayered composition.

Alternative confectionery layers can be chosen so as to provide structural protection to the multilayered composition. For example, a firm taffy could be used to give physical crush protection to layers containing soft fondant. Hard crystalline coatings can be used to give physical crush protection to soft caramel layers or centers.

Alternative confectionery layers including the fillings/centers can be chosen to give a contrasting soft or liquid texture. High fat and/or water levels in these soft or liquid layers or fillings can also provide greater and/or faster flavor or sensate release than firm or chewy layers such as taffy or gummy materials.

Alternative confectionery layers and their order in the product can be chosen to encourage or prevent moisture or oil migration between layers and/or the center during post-processing and storage (e.g. due to differences of moisture/Aw/oil content between adjacent layers). For example, this can allow starting confectionery materials of similar viscosity or texture to be extruded, deposited or laminated with ease as compared to materials having greater differences in viscosity or texture. Very thick materials and very soft materials can be more difficult to deposit, extrude or laminate with accuracy and without drips and tails.

In another embodiment, the confectionery layers can include confectionery particles or nonpareils within them. As laminated, extruded or deposited, the viscosity of the layer materials can be such that the particles are heterogeneously distributed through processing. Upon storage, the confectionery layer materials can gain moisture or oil through migration from contiguous (e.g. adjacent) layers and become less viscous thereby making the particles more visually and texturally noticeable than they were at the time of production.

In an embodiment, the multilayered confectionery products can be made by any suitable co-extrusion, co-depositing and/or laminating method. The confectionery layers can be co-extruded/co-deposited and/or laminated concurrently in any shapes and sizes and with any ornamental features (e.g. ridges). The multilayered confectionery products can be sheeted, stamped, pressed, rolled and/or printed on. Particulates can be added, for example, to the external surface of the layer via dropping, dusting, conveying, tumbling, dragging, stamping and/or hand applying.

Temperature can also be used to encourage or cause the moisture and oil migration. Processing temperatures can be used to make the various layers of similar or firmer texture to aid processing. For example, colder temperatures can be used to make jelly layers or caramel layer firm enough to be used in the preferred processing applications where they would be too soft or fluid-like at warmer temperatures. Processing temperatures can also be used to keep saturated solutions from crystallizing or hydrocolloidal suspensions from gelling until controlled layers firm them after a production process, for example, extrusion, deposition or lamination. Processing temperatures can also be used to keep molten materials from solidifying (e.g. to glass or crystal materials) until controlled layers firm them after a production process.

In an embodiment, specific choices of processing temperatures, confectionery ingredient concentrations and water activities can allow for material streams (e.g. the confectionery layers) that are co-extruded, co-deposited or laminated to be similar in texture. The texture of these material streams and resultant confectionery layers can become dissimilar as some confectionery layers become softer and/or harder than the other confectionery layers in the final (e.g. post-processed) multilayered confectionery product. The changes in textures, appearances and/or other characteristics in the confectionery layers can result from water migration, oil migration, gelling, crystallization and/or acid migration between adjacent confectionery layers of the multilayered confectionery product. Consequently, the final multilayered product can have confectionery layers with dissimilar textures even though the initial material streams used to make the multilayered product were similar in texture (e.g. fluid, viscous, pasty, etc.). For example, the final multilayered product can have confectionery layers that have their own specific characteristics such as, for example, texture, flavor, color, etc.

Water and/or oil migrating between the confectionery layers can carry various ingredients such as, for example, malted products, flavors, sensates, colors or other solids that could interact with the center layer, intermediate layers and/or exterior or outermost layer and alter the texture, flavor, cooling and/or color of the layers.

Water and/or oil migration between the confectionery layers can be prevented or controlled by placing protective barrier layers in strategic order in the multilayered confectionery. For example, a hydrophobic layer between two layers each having a different water activity can reduce or prevent moisture from moving, for example, from the higher water activity layer to the lower water activity layer. Similarly, oil migration between layers can be prevented or controlled by using a lipophobic layer.

The confectionery layers (e.g. center, shells and coatings) can having any suitable water (e.g. moisture) or oil content or level. For example, the water or oil content of the confectionery shell may be set at a level that dissolves the coatings over time during storage. The water or oil content can also be at a level where the coatings remain intact or substantially intact during storage.

Though the coating layers can be used to give structure during processing, the coatings can be made to soften so as to not be noticeable during consumption. For example, the moisture or oil content and/or water activities of the confectionery centers, confectionery shells and coatings (e.g. any of the layers) can be adjusted so that differences between the moisture or oil content and/or water activities between layers can promote water and/or oil migration between layers after production (e.g. as a result of hydroscopicity). As a result, the texture of each confectionery layer may or may not change. In an embodiment, the moisture may move to equilibrate water activities between contiguous or adjacent layers unless there are physical or hydrophobic barrier layers to prevent or control moisture movement (e.g. due to hydrophilicity).

Conversely, multiple textures during consumption may be preferred. To maintain the unique textures of each layer, the water and/or oil levels and/or water activities of each individual confectionery layer can be designed so as to prevent or control water and/or oil movement between layers (e.g. coating layer, confectionery shell layer, center layer). For example, the adjacent layers can comprise the same or similar water and/or oil levels and/or water activities. In addition, hydrophobic barriers or layers (e.g. coatings) can be used to prevent, limit or control moisture migration.

As with water, oil can migrate between layers. For example, higher liquid oil contents can create softer layer textures. Oil may move towards equilibrium between contiguous or adjacent layers (e.g. due to lipophilicity). Lipophobic barriers or layers (e.g. coatings) can be used to prevent, limit or control oil migration between layers.

Each of the confectionery layers may also comprise texture changing ingredients that can partially or entirely liquefy the layer over time. Such ingredients may include, for example, acids like lactic acid, malic acid, citric acid and phosphoric acid and enzymes like amylases and proteinases.

It should be appreciated that one or more ingredients such malted products, flavors, sensates, colors (e.g. azo free colors), sweetener, acids, actives and medicaments (e.g. listed below) can go in any layer of the confectionery/gum compositions of the present invention such as, for example, the coating, confectionery shells and/or center (e.g. each being a distinct layer of the confectionery product). Alternatively, the ingredients can be in the form of encapsulation, compaction, granulation and agglomeration to provide, for example, protected and longer-lasting ingredient components such as flavors and sensates. It should also be appreciated that any or all of the layers (e.g. coatings, confectionery shells and centers) can comprise any suitable number and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dextrin, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener can vary greatly and will depend on such factors as potency of the sweetener, rate of release, desired sweetness of the product, level and type of flavor used and cost considerations.

Combinations of sugar and/or sugarless sweeteners may be used in the confectionery. If a low calorie confectionery is desired, a low caloric bulking agent can be used. Example of low caloric bulking agents include: polydextrose; Raftilose; Raftilin; Fructooligosaccharides (NUTRAFLORA®); Palatinose oligosaccharide; Guar Gum Hydrolysate (SUN FIBER®); or indigestible dextrin (FIBERSOL®). However, other low calorie bulking agents can be used.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

In addition to a candy material, the confectionery shells and/or centers can comprise a chewing gum composition having a water-soluble bulk portion, a water-insoluble chewable gum base portion and typically water-insoluble flavoring agents. For example, the water-soluble portion dissipates with a portion of the flavoring agent over a period of time during chewing. The gum base portion can be retained in the mouth throughout the chew.

A variety of chewing gum formulations can be used to create the shells or centers. The chewing gum can comprise materials that allow it to be suitably combined with other confectioneries. For example, the chewing gum can be chocolate/fat tolerant, acid friendly, tack-free, etc.

Chewing gum generally consists of a water insoluble gum base, a water soluble portion, and flavors. The insoluble gum base generally comprises elastomers, resins, fats and oils, softeners, and inorganic fillers. The gum base may or may not include wax. The insoluble gum base can constitute approximately 5 to about 95 percent, by weight, of the chewing gum shell, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called ester gums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, sensates, acidulants, fillers, antioxidants, preservatives, actives, medicaments (as previously described) and other suitable components or processing aids or combinations thereof that provide desired attributes as known by the skilled artisan.

Softeners can be added to the chewing gum in order to optimize the chewability and mouth feel of the gum. The softeners, which are also known as plasticizers and plasticizing agents, generally constitute between approximately 0.5 to about 15% by weight of the chewing gum. The softeners may include caprenin, glycerin, lecithin and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

### EXAMPLES

By way of example and not limitation, the following examples are illustrative of various embodiments of the present invention.

### Example 1

Each layer of the multilayered confectionery can be prepared separately and maintained in fluid/viscous form. The confectionery layers can be pumped to an extruder, depositor or laminator. All or some of the desired layers can then be co-extruded, co-deposited or laminated at the same time according to the specific process as understood by the skilled artisan. Optionally, a liquid or paste filling can be added the multilayered product, for example, via injection after the first process. Optionally, an additional outer layer can be added to the multilayered product, for example, via pan coating (hard or soft), molten spray coating, waterfall, emersion, or placing in a mode and adding an outer material to the mold. Supersaturated layers can crystallize as they cool and dry. Fat-based layers can also firm as they cool and dry.

In various alternative embodiments, the multilayered confectionery product can comprise at least 3 or more combinations of layers as shown in the following chart (with a representative formula for each layer listed below):

TABLE 1
Alternative combinations for the multilayered confectionery product

| Confectionery Layer Type | 1 | 2 | 3 | 4 | 5 | 6 | 7 | 8 |
|---|---|---|---|---|---|---|---|---|
| Chewing Gum Layer | X | | X | | X | | X | X |
| Hydrocolloid Paste/Gel/Syrup | X | X | | X | | | X | |
| Layer | | | | | | | | |
| Gelatin Layer | | | X | | | | | |
| Pan Coating Layer | X | X | | | X | X | | X |
| Taffy Candy Layer | | X | X | X | X | X | X | |
| Compound Coating or Chocolate | | | | X | | X | | X |
| Layer | | | | | | | | |

TABLE 2
Chewing Gum Layer

| Ingredients | Amount (% by weight) |
|---|---|
| Sugar | 63.5 |
| Gum Base | 21.9 |
| Corn Syrup (63 DE) | 9.2 |
| Glycerin | 3.0 |
| Flavor | 1.6 |
| Sweetener (high intensity) | 0.3 |
| Lecithin | 0.3 |
| Water | 0.1 |
| Color | 0.05 |

A variety of processes for manufacturing chewing gum composition are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

TABLE 3
Hydrocolloid Paste Layer
Ingredients

OVERALL HYDROCOLLOID PASTE
GLUCOSE SYRUP
MIXTURE DRY SOLIDS
MIX HYDROCOLLOIDS-SOLUTION
FLAVOR
MIX HYDROCOLLOIDS-SOLUTION
WATER
LOCUST BEAN GUM
CARRAGEENAN
CRYSTAL SUGAR
MIXTURE DRY SOLIDS
CRYSTAL SUGAR
COCOA POWDER
MILK POWDER 26% (WHOLE)
SALT
CONDENSED FORMULA - HYDROCOLLOID PASTE
LOCUST BEAN GUM
CARRAGEENAN
CRYSTAL SUGAR
COCOA POWDER
WHOLE MILK IN POWDER
SALT
WATER
GLUCOSE SYRUP
FLAVOR

TABLE 4
Gelatin Layer

| Ingredients | Amount (% by weight) |
|---|---|
| OVERALL GELATIN FORMULA | |
| COOKED POLYOLS MASS | 87.1 |
| cooking water loss | −20.2 |
| sub-total | 66.9 |
| GELATIN SOLUTION | 46.5 |
| CITRIC ACID SOLUTION | 2.0 |
| HIGH INTENSITY SWEETENER | 0.07 |
| FLAVOR | 2 |
| COLOR A | 0.09 |
| COLOR B | 0.01 |
| sub-total | 117.5 |
| curing room water loss | −17.5 |
| total | 100 |
| COOKED POLYOLS MASS | |
| MALTITOL SYRUP | 59.7 |
| SORBITOL 70/70 | 40.2 |
| HIGH INTENSITY SWEETENER | 0.04 |
| | 100 |
| GELATIN SOLUTION | |
| GELATIN 250 BLOOM | 37 |
| WATER | 63 |
| | 100 |
| CITRIC ACID SOLUTION | |
| CITRIC ACID | 50 |
| WATER | 50 |
| | 100 |

TABLE 5
Pan Coating Layer

| Ingredients | Amount (% by weight) |
|---|---|
| COATING COMPONENT | |
| ISOMALT POWDER | 25.1 |
| ISOMALT SYRUP | 96.3 |
| MENTHOL POWDER BLEND | 8.9 |
| sub-total | 130.3 |
| coating water loss | −30.3 |
| Total | 100 |
| ISOMALT SYRUP | |
| ISOMALT POWDER | 97 |
| ARABIC GUM | 3 |
| COLOR A | 0.008 |
| COLOR B | 0.002 |
| | 100 |
| MENTHOL POWDER BLEND | |
| ISOMALT PF | 69 |
| MENTHOL POWDER | 30 |
| HIGH INTENSITY SWEETENER A | 0.8 |
| HIGH INTENSITY SWEETENER B | 0.2 |
| FLAVOR | 0.09 |
| | 100 |
| COLOR SOLUTION | |
| WATER | 95 |
| COLOR | 5 |
| | 100 |

TABLE 6
Taffy Candy Layer

| Ingredients | Amount (% by weight) |
|---|---|
| Sugar | 42 |
| Corn Syrup (42 DE) | 35 |
| Water | 10 |
| Sodium Citrate | 0.1 |
| Maltodextrin (18 DE) | 0.7 |
| Lecithin | 0.3 |
| Color | 0.05 |
| Gelatin (150 Bloom) | 1 |
| Water | 2 |
| Powdered Citric Acid | 1 |
| Fondant Sugar | 1.1 |
| Vegetable Fat | 6.5 |
| Flavor | 0.25 |

The gelatin is dissolved before the water addition. The gelatin/water are added to the cooked candy and whipped or pulled to incorporate air into the taffy. Powdered citric acid, fondant sugar, vegetable oil and flavor are added after the whipping or pulling step. The resultant taffy is separated into separate masses. Coloring is added to the separate masses. The separate masses are ready for co-extrusion to form the multilayered confectionery products

### Example 2

Pre-dried confectionery powder material such as, for example, fine powders of homogenous or heterogeneous particle size are provided. The powder material can be added to the center of a co-extruded product via a tube through the center of an extruder head or through a tube feeding into an area between two concentric tubular members of an extruder head. The confectionery powder product can be dragged along with the other extruded confectionery layers. Optionally, the dry confectionery powder material can be pushed/transported through a delivery tube via a screw or conveyor belt.

### Example 3

Confectionery powder material can be added to laminated confections by dropping the powder product onto a layer of confection. The powder layer is then covered with another confection layer.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A confectionery product comprising at least three distinct confectionery layers.

2. The confectionery product of claim 1, wherein at least one of the confectionery layers has a first texture during processing and a second texture after processing that is different from the first texture.

3. The confectionery product of claim 2, wherein the change from the first texture to the second texture of the confectionery layer is caused by water migration between adjacent confectionery layers.

4. The confectionery product of claim 3, wherein each of the confectionery layers has a separate water activity and wherein the water migration is caused by differences in the water activities between the adjacent confectionery layers.

5. The confectionery product of claim 2, wherein the change from the first texture to the second texture of the confectionery layer is caused by oil migration between adjacent confectionery layers.

6. The confectionery product of claim 5, wherein each of the confectionery layers has its own oil concentration and wherein the oil migration is caused by differences in the oil concentration between the adjacent confectionery layers.

7. The confectionery product of claim 1, wherein at least each of the confectionery layers is a material selected from the group consisting of chewing gum, powder, liquid, paste, hard candy, fat-based confectionery, crystallized pastes, pressed tablets, solid foam, shear thickening fluid, rework and combinations thereof.

8. The confectionery product of claim 1, wherein one of the confectionery layers comprises a coating.

9. The confectionery product of claim 8, wherein the coating comprises at least one component selected from the group consisting of sugars, polyols and combinations thereof.

10. The confectionery product of claim 1, wherein one of the confectionery layers comprises a pan coating.

11. The confectionery product of claim 1, wherein the confectionery layers comprise at least one ingredient selected from the group consisting of malted products, sweeteners, flavors, colors, sensates, acids, medicaments, actives and combinations thereof.

12. The confectionery product of claim 1, wherein at least one of the layers comprises a candy composition selected from the group consisting of hard boiled, chewy, caramel, fondant, chocolate, compound coating, jelly, gummy, glassy, crystalline, nougat, licorice, taffy, crystallized pastes, pressed tablets, solid foam, shear thickening fluid, rework and combinations thereof.

13. The confectionery product of claim 1, wherein one of the layers comprises a texture changing ingredient.

14. A confectionery product comprising at least three confectionery layers, the first layer comprises a confectionery center, the second layer comprises a coating surrounding the confectionery center, the third layer comprises a confectionery shell, wherein the coating provides a barrier to control water migration between the confectionery center and the confectionery shell due to hydroscopic characteristics.

15. A confectionery product comprising at least three confectionery layers, the first layer comprises a confectionery center, the second layer comprises a coating surrounding the confectionery center, the third layer comprises a confectionery shell, wherein the coating provides a barrier to control water migration between the confectionery center and the confectionery shell due to hydrophobic characteristics.

16. A confectionery product comprising at least three confectionery layers, the first layer comprises a confectionery center, the second layer comprises a coating surrounding the confectionery center, the third layer comprises a confectionery shell, wherein the coating provides a barrier to control oil migration between the confectionery center and the confectionery shell due to lipophobic characteristics.

17. A confectionery product comprising at least three confectionery layers, the first layer comprises a confectionery center, the second layer comprises a confectionery shell surrounding the confectionery center, the third layer comprises a another confectionery shell surrounding the second layer, wherein the first layer, the second layer and the third layer each has a water content or water activity that causes water migration between the adjacent layers.

18. The confectionery product of claim 17, wherein the first layer, the second layer and the third layer each has a texture that changes due to the water migration.

19. A confectionery product comprising at least three confectionery layers, the first layer comprises a confectionery center, the second layer comprises a confectionery shell surrounding the confectionery center, the third layer comprises a another confectionery shell surrounding the second layer, wherein the first layer, the second layer and the third layer each has a water content or water activity that prevents water migration between the adjacent layers.

20. A confectionery product comprising at least three confectionery layers, the first layer comprises a confectionery center, the second layer comprises a confectionery shell surrounding the confectionery center, the third layer comprises a another confectionery shell surrounding the second layer, wherein the first layer, the second layer and the third layer each has an oil content that causes oil migration between the adjacent layers.

21. The confectionery product of claim 20, wherein the first layer, the second layer and the third layer each has a texture that changes due to the oil migration.

22. A confectionery product comprising at least three confectionery layers, the first layer comprises a confectionery center, the second layer comprises a confectionery shell surrounding the confectionery center, the third layer comprises a another confectionery shell surrounding the second layer, wherein the first layer, the second layer and the third layer each has an oil content that prevents oil migration between the adjacent layers.

23. A method of making a confectionery product, the method comprising:
providing a first confectionery center layer;
surrounding the first confectionery center layer with a second confectionery layer;
surrounding the second confectionery layer with a third confectionery layer; and
allowing a component selected from the group consisting of water, oil and combinations thereof to migrate between the layers of the confectionery product by controlling the amount in the layers of a component selected from the group consisting of water content, water activity, oil content and combinations thereof.

24. A method of making a confectionery product, the method comprising:
depositing at least one confectionery center layer into a mold; and
adding a second confectionery layer to the mold to surround the confectionery center layer with the second confectionery layer;
adding a third confectionery layer to the mold to surround the second confectionery layer with the third confectionery layer; and
allowing a component selected from the group consisting of water, oil and combinations thereof to migrate between the layers of the confectionery product by controlling the amount in the layers of a component selected from the group consisting of water content, water activity, oil content and combinations thereof.

25. A method of making a multilayered confectionery product, the method comprising:
adding a first confectionery material, a second confectionery material and a third confectionery material to an extruder;
co-extruding the first, second and third confectionery materials to form the multilayered confectionery product;
cutting the multilayered confectionery product into pieces; and
allowing a component selected from the group consisting of water, oil and combinations thereof to migrate between the layers of the multilayered confectionery product by controlling the amount in the materials of a component selected from the group consisting of water content, water activity, oil content and combinations thereof.

26. A method of making a multilayered confectionery product, the method comprising:
providing a first confectionery material, a second confectionery material and a third confectionery material;
co-depositing the confectionery materials on to an apparatus selected from the group consisting of a mold, a belt and combinations thereof to form the multilayered confectionery product; and
allowing a component selected from the group consisting of water, oil and combinations thereof to migrate between the materials of the multilayered confectionery product by controlling the amount in the materials of a component selected from the group consisting of water content, water activity, oil content and combinations thereof.

27. A method of making a confectionery product, the method comprising:
providing a first confectionery layer;
laminating the first confectionery layer with a second confectionery layer;
laminating the second confectionery layer with a third confectionery layer; and
allowing a component selected from the group consisting of water, oil and combinations thereof to migrate between the layers of the confectionery product by controlling the amount in the layers of a component selected from the group consisting of water content, water activity, oil content and combinations thereof.

28. A method of making a confectionery product, the method comprising:
providing a first confectionery layer;
adding a second confectionery layer to the first confectionery layer;
adding a third confectionery layer to the second confectionery layer; and
preventing a component selected from the group consisting of water, oil and combinations thereof from migrating between the layers of the confectionery product by controlling the amount in the layers of a component selected from the group consisting of water content, water activity, oil content and combinations thereof.
